(19) United States
(12) Patent Application Publication
(10) Pub. No.: US 2005/0114302 A1
(43) Pub. Date: May 26, 2005

(54) Method for fast searching and displaying a genealogical tree of patents from a patent database

(76) Inventors: Young-Gyun Lee, Seoul (KR); Sik Choi, Kyonggi-do (KR); Ji-Rak Jung, Seoul (KR); Il-Soo Kim, Seoul (KR)

Correspondence Address: Paul J Farrell;Dilworth & Barrese, 333 Earle Ovington Blvd, Uniondale, NY, 11553, US

(21) Appl. No.: 10/508,687

(22) PCT Filed: Jun. 1, 2002
(86) PCT No.: PCT/KR02/01044

(30) Foreign Application Priority Data
Mar. 19, 2002 (KR) 2002/14761

(51) Int. Cl. G06F 7/00

(52) U.S. Cl. 707/3

(57) ABSTRACT

The present invention discloses a method for fast searching a genealogical tree among patents recorded in a patent database and displaying the searched results. In details, the present invention extracts the patents having fields containing genealogical tree information from a patent database and makes the patent numbers in the same format and deletes the repeated paren patents and finally generates family relation sets and family member sets to generate the genealogical tree.

### BACKGROUND OF THE INVENTION

This invention relates to a method for fast searching a genealogical tree among patents recorded in a patent database and displaying the searched results.

### PRIOR ART OF THE INVENTION

The more a society becomes industrialized, the more the information competition between companies resembles a war. Especially as the patent-related information has the information about technological rights of a corresponding company, it becomes more and more important. Accordingly now it became necessary to get more information from such patent-related information as soon as possible.

However so far most of commercial patent analysis systems have analyzed an object only based on the bibliographical information of each patent related to the object one-dimensionally and in fragments.

### TECHNICAL SUBJECTS OF THE INVENTION TO BE SOLVED

The present invention provides new analysis objects and a new patent analysis method, whose analysis result level is different from the prior patent analysis systems'. Especially the present invention provides a patent analysis method can be easily find a genealogical route that shows a route of an object patent filed with a Patent Office from it's parent patents.

The information about such a genealogical tree could not be got at a time through the prior art but could be got after confirming the data investigated one by one repeatedly through several methods. Therefore it took much time.

### SIMPLE EXPLANATION OF DRAWINGS OF THE PRESENT INVENTION

FIG. 1 illustrates a whole flowchart of a method for analyzing a genealogical tree quickly and providing the analyzed results.

FIG. 2 illustrates a table for explaining the family relation set generated according to the present invention.

FIGS. 3 and 4 illustrate genealogical trees generated from a family relation set according to FIG. 2.

FIG. 5 illustrates a screen layout of software made by using the present invention.

FIG. 6 illustrates an enlarged genealogical tree according to the present invention.

### COMPOSITION OF THE INVENTION

The present invention that was invented to solve the above subjects comprises the following steps.

A method for fast analyzing genealogical trees related to a patent from a patent database (hereinafter we call them as “prior patent database”) with fields having information about that via which genealogical tree the patent was filed from its parent patent, and for providing the analyzed results, the method comprises the steps for:
extracting the filed year, the application number, the registered number about patents (hereinafter we call them as “child patent”) having information in their genealogical fields among patents stored in the prior patent databases;
selecting one among the predetermined patent classifications (hereinafter we call them as “patent classification”) from the extracted child patent's registered number and application number in order to classify the corresponding patents' kinds;
extracting the filed year and the application number of each patent (hereinafter we call them as “parent patent”) corresponding to each application number recorded in each genealogical field of the child patent;
generating a genealogy data set that associates each of the extracted child patents with its parent patent as an independent pair and arrayed the pairs in a table, and recording the generated genealogy data set in the form of ‘child patent’s filed year-child patent's application number-patent classification (hereinafter we call it as “child patent number”)-child patent's registered number-parent patent's filed year-parent patent's application number-patent classification (we call it as “parent patent number”) in order to standardize each patent number in the same format each other;
selecting a pair among the data pairs stored in the genealogy data set;
storing the child patent and the parent patent of the selected pair without distinction in the temporary storing means a ‘Unique application number set’ in the form of ‘filing year-application number-patent classification for each patent (hereinafter we call each patent stored in the ‘Unique application number set’ as ‘unique patent’ and the number format recorded for each unique patent as ‘unique number’);
deleting the pair selected as the unique application number set from the genealogy data set and storing the deleted pair in a separate storing means a ‘Family relation set’ in the form of ‘child patent number-parent patent number’;
selecting each unique patent from the ‘Unique application number set’ one by one sequentially and extracting all the pairs that the unique number of the selected unique patent is equal to the number of the child patent number or the parent patent number of the genealogy data set;
deleting the extracted pair from the genealogy data set with the same method;
storing the extracted pair in the ‘Unique application number set’ and ‘Family relation set’ without repeatedly storing the same unique number in the ‘Unique application number set’;
repeating the steps until a new unique number is not added into a ‘Unique application number set’;
closing the ‘Unique application number set’ when a unique number is not added any more into a ‘Unique application number set’;
closing a corresponding ‘Family relation set’ at the same time with the close of the ‘Unique application number set’ and storing the closed ‘Family relation set’ in the name of the child patent number having the oldest filing date, which is being regarded as the representative name;
copying and storing the closed ‘Unique application number set’ in the same name with the representative name of the stored ‘Family relation set’ into a separate storing means, a ‘Family member set’ in the form of ‘filing year-application number-patent classification-representative name’ or ‘filing year-application number-patent classification-registered number-representative name’;
resetting the data that were stored in the ‘Unique application number set’ temporarily after completion of the storing into the ‘Family member set’;
selecting another pair from the pairs remaining in the genealogy data set and generating multiple Family relation sets and Family member sets;
arraying the generated the entire Family member set into a table set sequentially and storing;
checking if the number inputted by a user is one of the patent numbers, that is register number or application numbers, stored in the Family member set and if the check result is true, extracting the representative name of the Family member set to which the patent number belongs; and
extracting the Family relation set having the same representative name with the representative name extracted in the above step and reading the corresponding genealogical information from the extracted Family relation set and displaying the read information in the form of the genealogy tree to provide users with.

At this time, the step for displaying the genealogy tree from the Family relation set comprises the steps of:
arraying the patent pairs stored in a Family relation set in the order (C1, C2, . . . , Ci, . . . ) of application number of a child patent that was filed quite recently;
arraying the parent patents corresponding to each arrayed child patent (Ci, i=1, 2, 3, . . . ) in the order (Pi1, Pi2, Pi3, . . . ) of application number of the parent patent that was filed quite recently;
searching a patent pair one by one sequentially from the most recently filed child patent's application number (C1) through all the child patents' application numbers (Ci), wherein the search begins from the parent patent's number (Pi1) which was most recently filed among the corresponding parent patents' numbers (Pi1, Pi2, Pi3, . . . ) and the searched patent pair has the child patent numbers (Cm, m=2, 3, 4, . . . ) same to the parent patent's number Pi1;
comparing between the parent patent numbers (Pm1, Pm2, Pm3, . . . ) recorded in the searched pair Cm and the parent patent numbers (Pi1, Pi2, Pi3, . . . ) of a child patent number Ci and deleting the same parent patent numbers from the parent patent numbers (Pi1, Pi2, Pi3, . . . ) of the corresponding child patents;
repeating the above steps for a parent patent having next the most recently filed date among the yet remaining undeleted parent patent numbers and continuing the steps for all child patents and parent patents; and
displaying only the remaining undeleted parent patent numbers for each child patent number stored in the Family relation set by connecting lines having the filed year axis.

In the line connecting step, it is characteristic that if the patent to display was not filed by using a regular application or the patent's right is not effective because of abandonment or cancellation, then the corresponding patent is not displayed only except when it is difficult to reveal that they have the same genealogy tree because the line connecting the corresponding patent filed by an irregular application with other patents in the same genealogy tree is disconnected.

On the other hand, it is desirable that the present invention further comprises the steps of:
if the patent to display was not filed by using a regular application or the patent's right is not effective because of abandonment or cancellation, storing the patent not to display on a genealogy tree into a separate storing means of a computer;
if a user wants, extracting the stored patents hidden on a genealogy tree and the child patents whose parent patents are the stored patents hidden on a genealogy tree and further displaying the relationship of the extracted child patents and parent patents on a genealogy tree; and
if a user wants, displaying the list of the stored hidden patents.

And it is desirable that each patent to be displayed on a genealogical tree is displayed in a box form having a constant size and if a user lays a mouse cursor on the box, then the bibliographical information about the corresponding patent is displayed.

At this time, it is desirable that if a user lays a mouse cursor on the box and clicks the right button of the mouse, then a screen to ask whether the user wants to see the full text about the corresponding patent is displayed and if the user selects the full text, then the full text is provided.

And it is desirable that if a user lays a mouse cursor on the box and clicks the right button of the mouse, then a screen is displayed to ask whether the user wants only patents having the same applicants with the corresponding patent, the same inventors with the corresponding patent, the same IPC classification code with the corresponding patent or the same UPC classification code with the corresponding patent to be displayed emphatically on a genealogical tree being displayed currently, and if the user selects one of the same applicant, inventor, IPC classification code and UPC classification code, then the patents corresponding to the selected condition are displayed emphatically on the genealogical tree.

And at the present invention it is desirable that if a user selects a patent displayed on a genealogical tree by using a mouse cursor, then only the patents described directly in the fields for a genealogical tree in prior patent databases are extracted and only the connection lines between the selected patents and the extracted patents on a genealogical tree are displayed emphatically.

As a preferred embodiment of the present invention, which is based on patent database according to the present invention, the prior patent database can be made from the US registered patent database.

In this case it is preferable that the genealogical tree information fields contain ‘Patent application case text’ of the first page of US patent application or contents recorded in ‘Related US application data’ or contents recorded between ‘patent's title’ of a patent application and ‘background of the invention’.

And it is preferable that the objects of the right displayed on a genealogical tree comprises utility patents including laid-opened or issued patent/utility regular applications, provisional applications, reissued patents, applications withdrawn to avoid the duplicated right, applications canceled because of the continuous application, and co-applications and design patents.

And it is preferable that if the corresponding patent corresponds to a utility classification, then ‘U1’ is allocated as a patent classification information, or else if corresponding to a design classification, then ‘D1’ is allocated, or else if corresponding to a provisional application, then ‘P1’ is allocated, wherein if the data recorded in the prior patent databases is recorded incorrectly and the different patents have the same number, then to the last number of the above patent classification information in order to distinguish the processed data a new number like 2, 3, 4, . . . , is allocated.

At this time it is preferable that the present invention further comprises the steps of:
by a user displaying the list of the related patents on a screen after searching the patents using the prior patent databases and especially for the patents having the genealogical tree information among the list making quick search by using the registered number or application number of the family member set and checking whether the number inputted by a user is one of the registered patent number or application number stored in the family member set and if the inputted number is one of the registered patent number or application number, then displaying the mark on a screen; and
if a user selects a patent having the separately displayed mark, then extracting the genealogical tree of the selected patent from the family member set and displaying or else if a user wants a genealogical tree, then generating a genealogical tree from the family relation set and displaying.

And also it is preferable that the present invention further comprises a step of generating a database from the prior patent databases, which stores and operates only the genealogical tree information and generating the genealogical tree information or genealogical tree according to the user's search results and displaying.

And it is preferable that in case of displaying and providing a genealogical tree, according to a user's selection each patent displayed on a genealogical tree is displayed by using one of application number, registered year, registered number, inventor, IPC classification, UPC classification, applicant and provided.

Hereinafter we explain the present invention more detailed by referencing the attached drawings.

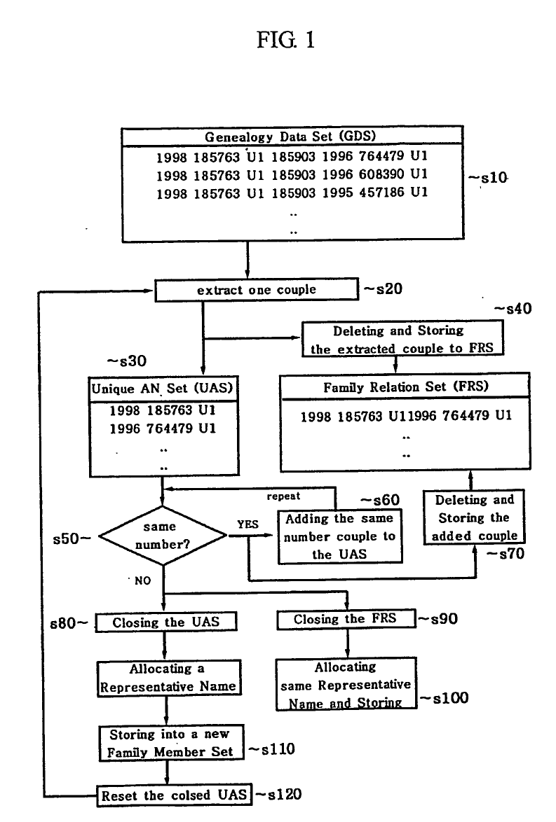

FIG. 1 illustrates a whole flowchart of a method for analyzing a genealogical tree quickly and providing the analyzed results.

At first in the present invention the filed year, the application number, the registered number about patents (hereinafter we call them as “child patent”) having information in their genealogical tree fields among patents stored in the prior patent database are extracted and one among the predetermined patent classifications (hereinafter we call them as “patent classification”) from the extracted child patent's registered number and application number in order to classify the corresponding patents' kinds is selected.

FIG. 1 is explaining about a case the prior patent database were constructed based on US registered patent database.

At this time, the genealogical tree information fields contain ‘Patent application case text’ of the first page of US patent application or contents recorded in ‘Related US application data’ or contents recorded between ‘patent's title’ of a patent application and ‘background of the invention’.

If the corresponding patent corresponds to a utility classification, then ‘U1’ is allocated, or else if corresponding to a design classification, then ‘D1’ is allocated, or else if corresponding to a provisional application, then ‘P1’ is allocated, or else if the data recorded in the prior paten databases is recorded incorrectly and the different patents have the same number, then to the last number of the above patent classification information in order to distinguish the processed data a new number like 2, 3, 4, . . . , is allocated.

A genealogy data set is generated, wherein the genealogy data set is associated each of the extracted child patents with a parent patent of each extracted child patent as an independent pair and arrayed the pairs in a table.(step 10).

And the generated genealogy data set is recorded in the form of ‘child patent’s filed year-child patent's application number-patent classification-child patent's registered number-parent patent's filed year-parent patent's application number-patent classification in order to standardize each patent number in the same format each other.

A pair is selected among the data pairs stored in the genealogy data set.(step 20).

The child patent and the parent patent of the selected pair are stored without distinction in the temporary storing means a unique application number set.(step 30).

At this time, each patents is stored in the form of ‘filing year-application number-patent classification for each patent. And the set selected as the unique application number set from the genealogy data set is deleted and the deleted pair is stored in a separate storing means a family relation set in the form of ‘child patent number-parent patent number’. (step 40).

Each unique patent is selected from the unique application number set one by one sequentially and it is examined whether the selected patent number is equal to the child patent number of the genealogy data set. After the examination, it is examined whether the selected patent number is equal to the parent patent number of the genealogy data set. (step 50).

If the selected patent number is equal to the number of the child patent number or the parent patent number of the genealogy data set, then extracts corresponding pairs and stores in the unique application number set without repeatedly storing the same patent number in the unique application number set.(step 60).

And the extracted pair is deleted from the genealogy data set and the extracted pair is stored in the family relation set. (step 70) The above steps are repeated until a new unique number is not added into a unique application number set and the unique application number set is closed when a unique number is not added any more into the unique application number set. (step 80).

And the corresponding family relation set at the same time with the close of the unique application number set is closed (step 90) and the closed family relation set is stored in the name of the child patent number having the oldest filing date, which is being regarded as the representative name. (step 100).

The closed unique application number set is copied and stored in the same name with the representative name of the stored family relation set into a separate storing means, a family member set in the form of ‘filing year-application number-patent classification-representative name’ or ‘filing year-application number-patent classification-registered number-representative name’. (step 110).

The data that were stored in the unique application number set temporarily is reset after completion of the storing into the family member set. (step 120).

Another pair is selected from the pairs remaining in the genealogy data set and generating multiple family relations set and family member set and all generated the family member sets are arrayed into a table set sequentially and stored.

And the invention checks if the number inputted by a user is one of the patent numbers, register numbers and application numbers stored in the family member set and if the check result is true, then extracts the representative name of a family member set which the patent number belongs to and extracts the family relation set having the same representative name with the representative name extracted in the above step and reads the corresponding genealogical information from the extracted family relation set and displays the read information in the form of the genealogy tree to provide users with.

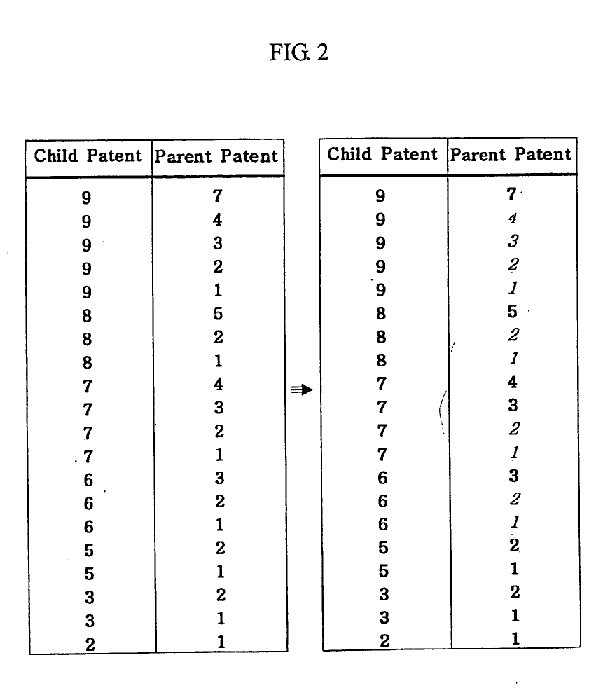

FIG. 2 illustrates a table for explaining the family relation set generated according to the present invention. As shown in the FIG. 2, child patents and parent patents are arrayed. For convenience, we define a patent with greater number was filed more recently than other patents.

According to the left table of the FIG. 2, a child patent ‘9’ has parent patents ‘7’, ‘4’, ‘3’, ‘2’, ‘1’ and a child patent ‘8’ has parent patents ‘5’, ‘2’, ‘1’. Other child patents ‘7’, ‘6’, ‘5’, ‘3’, ‘2’ has parent patents as shown in the table of the FIG. 2.

The present invention searches a patent pair one by one sequentially from the quite recently filed child patent's application number ‘9’ through all the child patents' application numbers, wherein the search begins from the parent patent number ‘7’ which was filed quite recently among the parent patent numbers of the child patent ‘9’ and checks whether the parent patent number ‘7’, is consisting of the child patent numbers (‘8’, ‘7’, ‘6’, ‘5’, ‘3’, ‘2’) of other pairs.

According to FIG. 2, a parent patent ‘7’ of a child patent ‘9’ is used as a child patent of other patent pairs. Therefore in this case the invention compares the parent patents (4, 3, 2, 1) of another child patent ‘9’ except the corresponding number ‘7’ with the parent patents (4, 3, 2, 1) of the child patent ‘7’ and if there are the same numbers, the same numbers are deleted from the parent patent group of a child patent ‘9’.

As shown in the right table of the FIG. 2, the patents ‘4, 3, 2, 1’ were deleted from a parent patent group of a child patent ‘9’ because the patents ‘4, 3, 2, 1’ are the same patents.

If the above steps were finished for a parent patent (‘7’), which was filed most recently among the parent patents of a child patent ‘9’, then the invention repeats the above steps for a parent patent having the most recently filed date among the parent patent numbers remaining undeleted yet.

At the table illustrated in the FIG. 2 there are no such parent patents for a child patent ‘9’ and so the invention moves to a child patent ‘8’, which was filed at the next recent date and deletes a parent patent ‘5’ of a child patent ‘8’ as described in the above.

In the FIG. 2 the parent patents remaining undeleted were displayed thickly and the deleted parent patents were displayed blurredly.

Like the above method only for the remaining undeleted parent patents for each child patent number stored in the family relation set a genealogical tree is made by connecting lines having the filed year axis.

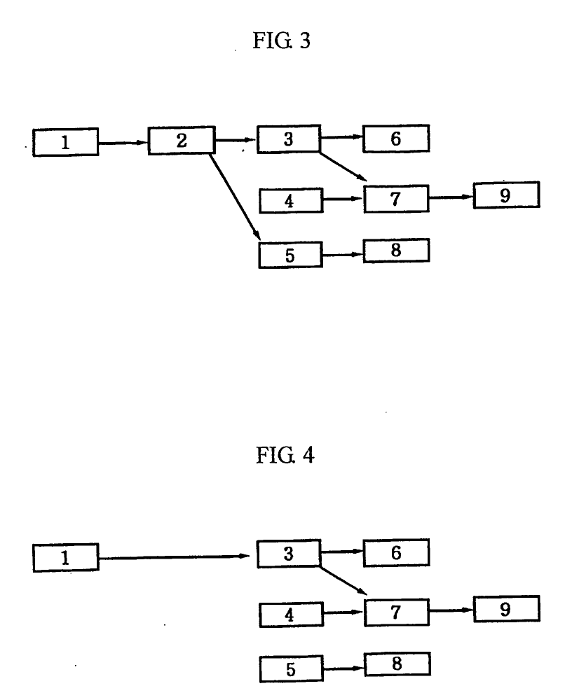

FIGS. 3 and 4 illustrate genealogical trees generated from a family relation set according to FIG. 2.

If a patent to display was not filed by using a regular application or the patent's right is not effective because of abandonment or cancellation, then the corresponding patent is not displayed only except when it is difficult to show that they have the same genealogy tree because the line connecting the corresponding patent filed by an irregular application with other patents of the same genealogy tree is disconnected.

That is, in FIG. 3 a patent ‘2’ is a patent corresponding to a provisional application or is not effective because the patent was abandoned or canceled. Accordingly if the patent ‘2’ is not displayed as in FIG. 4, then the genealogical relationship with other patents of patents ‘5’ and ’8’ cannot be seen.

Accordingly in this case although the corresponding patent was filed via a non-regular application or its right is not effective any more because of the abandonment or cancellation for the patent, if they are not displayed on a genealogical tree, then the connection lines with other patents are cut and it may be difficult to display that they belong to the same genealogical tree, they are displayed on a genealogical tree as in FIG. 3.

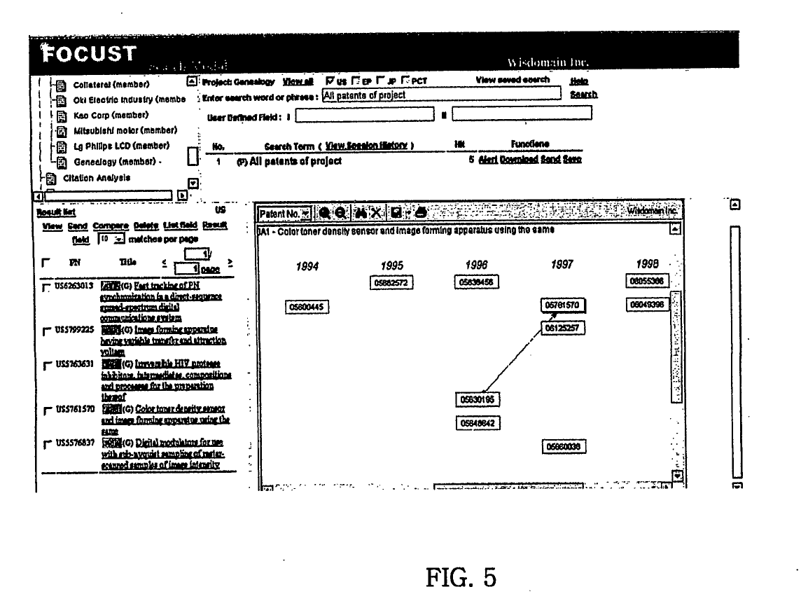

FIG. 5 illustrates a screen constitution of software made by using the present invention.

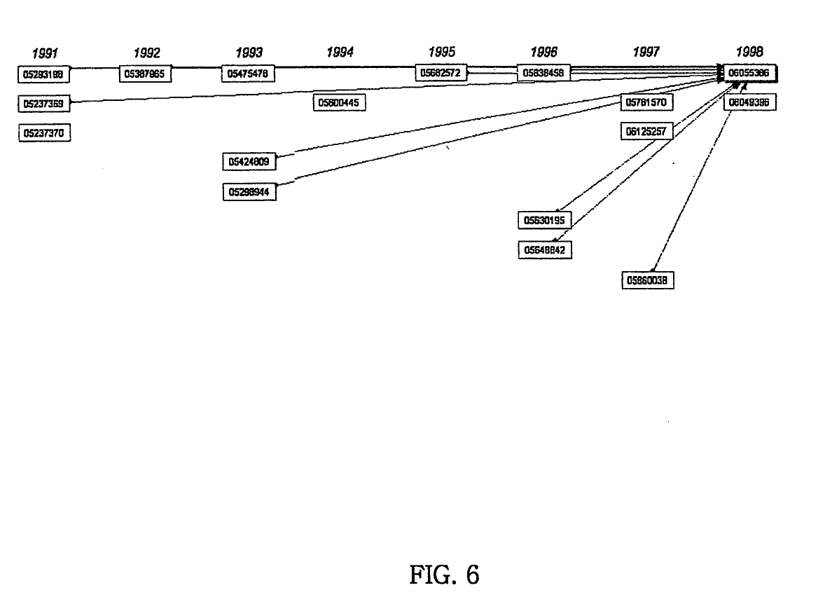

And FIG. 6 illustrates an enlarged genealogical tree according to the present invention.

As shown, it is preferable that each patent displayed on a genealogical tree is displayed in a certain sized box. And also it is preferable that in this case, if a user lays a mouse cursor upon the box, then the bibliographic information corresponding to the patent is displayed.

At this time, it is desirable that if a user lays a mouse cursor on the box and clicks the right button of the mouse, then a screen to ask whether the user wants to see the full text about the corresponding patent is displayed and if the user selects the full text, then the full text is provided.

And it is desirable that if a user lays a mouse cursor on the box and clicks the right button of the mouse, then a screen is displayed to ask whether the user wants that only the patent having the same applicants with the corresponding patent or the same inventors with the corresponding patent or the same IPC classification code with the corresponding patent or the same UPC classification code with the corresponding patent are displayed emphatically on a genealogical tree being displayed currently, and if the user selects one of the same applicants, inventors, IPC classification code and UPC classification code, then the patents corresponding to the selected conditions are displayed emphatically on a genealogical tree.

And it is desirable at the present invention that if a user selects a patent in a box displayed on a genealogical tree using a mouse cursor, then the only patents described directly in the fields for a genealogical tree in prior patent databases are extracted and the only connection lines between the selected patents and the extracted patents on a genealogical tree are displayed emphatically.

But software developers can modify such a function variously and it is apparent that any modifications of the present invention belong to the present invention as far as they apply the present invention.

### THE EFFECTS OF THE PRESENT INVENTION

It is possible to see whether an object patent was filed from any parent patent via any genealogical tree at a glance according to the present invention.

Accordingly it is possible to catch the competitor's technology development strategy at a glance only by simple operation according to the present invention.

1. A method for fast analyzing genealogical trees related to a patent from patent database (hereinafter we call them as “prior patent database”) with fields having information about that via any genealogical tree the patent was filed from its parent patent, and for providing said analyzed results, the method comprising the steps of:
extracting the filed year, the application number, the registered number about patents (hereinafter we call them as “child patent”) having information in their genealogical tree fields among patents stored in the prior patent database;
selecting one among the predetermined patent classifications (hereinafter we call them as “patent classification”) from said extracted child patent's registered number and application number in order to classify the corresponding patents' kinds;
extracting the filed year and the application number of each patent (hereinafter we call them as “parent patent”) corresponding to each application number recorded in each genealogical tree field of the child patent;
generating a genealogy data set that associated each of said extracted child patents with a parent patent of each extracted child patent as an independent pair and arrayed the pairs in a table, and recording the generated genealogy data set in the form of ‘child patent’s filed year-child patent's application number-patent classification (hereinafter we call it as “child patent number”)-child patent's registered number-parent patent's filed year-parent patent's application number-patent classification (we call it as “parent patent number”) in order to standardize each patent number in the same format each other;
selecting a pair among the data pairs stored in the genealogy data set;
storing the child patent and the parent patent of said selected pair without distinction in the temporary storing means a unique application number set in the form of ‘filing year-application number-patent classification for each patent (hereinafter we call each patent stored in the unique application number set as ‘unique patent’ and the number format recorded for each unique patent as ‘unique number’);
deleting the pair selected as the unique application number set from the genealogy data set and storing the deleted pair in a separate storing means a family relation set in the form of ‘child patent number-parent patent number’;
selecting each unique patent from the unique application number set one by one sequentially and extracting all the pairs where the unique number of said selected unique patent is equal to the number of the child patent number or the parent patent number of the genealogy data set;
deleting said extracted pair from the genealogy data set with the same method described in the above;
storing said extracted pair in the unique application number set and the family relation set without repeatedly storing the same unique number in the unique application number set;
repeating said steps until no unique number is newly added into the unique application number set;
closing the unique application number set when a unique number is not added any more into the unique application number set;
closing the corresponding family relation set at the same time with the close of the unique application number set and storing said closed family relation set in the name of the child patent number having the oldest filing date, which is regarded as the representative name;
copying and storing said closed unique application number set in the same name with the representative name of said stored family relation set into a separate storing means, a family member set in the form of ‘filing year-application number-patent classification-representative name’ or ‘filing year application number-patent classification-registered number-representative name’;
resetting the data that were stored in the unique application number set temporarily after completion of the storing into the family member set;
selecting another pair from the pairs remaining in the genealogy data set and generating multiple family relation set and family member set;
arraying all the generated family member sets into a table set sequentially and storing;
checking if the number input by a user is one of the patent numbers, that is a registered number or an application number stored in the family member set and if the check result is true, extracting the representative name of a family member set which the patent number belongs to; and
extracting the family relation set having the same representative name with the representative name extracted in the above step and reading the corresponding genealogical information from said extracted family relation set and displaying said read information in the form of the genealogy tree to provide users with.

2. A method as set forth in claim 1, wherein said step for displaying the genealogy tree from the family relation set comprises the steps of:
arraying the patent pairs stored in a family relation set in the order (C1, C2, . . . Ci, . . . ) of application number of a child patent that was filed quite recently;
arraying the parent patents corresponding to each arrayed child patent (Ci, I=1, 2, 3, . . . ) in the order (Pi1, Pi2, Pi3,) of application number of the parent patent that was filed quite recently;
searching a patent pair one by one sequentially from the quite-recently filed child patent's application number (C1) through all the child patents' application numbers (Ci), wherein the search begins from the parent patent's number (Pi1) which was filed quite recently among the corresponding parent patents' numbers (Pi1, Pi2, Pi3, . . . ) and the searched patent pair has the parent patent's number Pi1 consisting of the child patent numbers (Cm, m=2, 3, 4, . . . ) of other pairs;
comparing the parent patent numbers (Pm1, Pm2, Pm3, . . . ) recorded in the searched pair Cm and the parent patent numbers (Pi1, Pi2, Pi3, . . . ) of a child patent number Ci and deleting the same parent patent numbers from the parent patents numbers (Pi1, Pi2, Pi3, . . . ) of the corresponding child patents;
repeating the steps for a parent patent having next the most recently filed date among the yet remaining undeleted parent patent numbers and continuing the steps for all child patents and parent patents; and
displaying only the remaining undeleted parent patent numbers for each child patent number stored in the family relation set by connecting lines having the filed year axis.

3. A method as set forth in claim 2, wherein in said step for line connecting, it is characteristic that if the patent to display was not filed by using a regular application or the patent's right is not effective because of abandonment or cancellation, then the corresponding patent is not displayed only except when it is difficult to show that they have the same genealogy tree because the line connecting the corresponding patent filed by an irregular application with other patents of the same genealogy tree is disconnected.

4. A method as set forth in claim 3, wherein said method further comprises the steps of:
if the patent to display was not filed by using a regular application or the patent's right is not effective because of abandonment or cancellation, storing the patent not to display on a genealogy tree into a separate storing means of a computer;
if a user wants, extracting the stored patents not to display on a genealogy tree and the child patents whose parent patents are the stored patents not to display on a genealogy tree and further displaying the relationship of the extracted child patents and parent patents on a genealogy tree; and
if a user wants, displaying the list of the stored patents not to display.

5. A method as set forth in claim 1, wherein in case said prior patent database was constructed by using US registered patent databases,
the genealogical tree information fields contain ‘Patent application case text’ of the first page of US patent application or contents recorded in ‘Related US application data’ or contents recorded between ‘patent's title’ of a patent application and ‘background of the invention’,
and the objects of the right displayed on a genealogical tree comprises utility patents including laid-opened or issued patent/utility model regular applications, provisional applications, reissued patents, applications withdrawn to avoid the duplicated right, applications canceled because of the continuous application and co-applications, and design patents,
and if the corresponding patent corresponds to a utility classification, then ‘U1’ is allocated, or else if corresponding to a design classification, then ‘D1’ is allocated, or else if corresponding to a provisional application, then ‘P1’ is allocated, or else if the data recorded in the prior patent databases are recorded incorrectly and the different patents have the same number, then to the last number of the above patent classification information in order to distinguish the processed data a new number like 2, 3, 4, . . . , is allocated.

6. A method as set forth in claim 5, wherein said method further comprises the steps of:
by a user displaying the list of the related patents on a screen after searching the patents using the prior patent databases and especially for the patents having the genealogical tree information among the list making quick search by using the registered number or application number of the family member set and checking whether the number inputted by a user is one of the registered patent number or application number stored in the family member set and if the inputted number is one of the registered patent number or application number, then displaying the mark on a screen; and
if a user selects a patent having the separately displayed mark, then extracting the genealogical tree of the selected patent from the family member set and displaying or else if a user wants a genealogical tree, then generating a genealogical tree from the family relation set and displaying.

7. A method as set forth in claim 5, wherein said method further comprises a step of generating a database from the prior patent databases, which stores and operates only the genealogical tree information and generating the genealogical tree information or genealogical tree according to the user's search results and displaying.

8. A method as set forth in claim 5, wherein it is characteristic that in case of displaying and providing a genealogical tree, according to a user's selection each patent displayed on a genealogical tree is displayed by using one of application number, registered year, registered number, inventor, IPC classification, UPC classification, applicant and provided.

9. A method as set forth in claim 1, wherein it is characteristic that each patent to be displayed on a genealogical tree is displayed in a box form having a constant size and if a user lays a mouse cursor on the box, then the bibliographical information about the corresponding patent is displayed.

10. A method as set forth in claim 9, wherein it is characteristic that if a user lays a mouse cursor on the box and clicks the right button of the mouse, then a screen to ask whether the user wants to see the full text about the corresponding patent is displayed and if the user selects the full text, then the full text is provided.

11. A method as set forth in claim 9, wherein it is characteristic that if a user lays a mouse cursor on the box and clicks the right button of the mouse, then a screen is displayed to ask whether the user wants the only the patents to be displayed emphatically on a genealogical tree being displayed currently having the same applicants with the corresponding patent or the same inventors with the corresponding patent or the same IPC classification code with the corresponding patent or the same UPC classification code with the corresponding patent, and if the user selects one of the same applicants, inventors, IPC classification code and UPC classification code, then the patents corresponding to the selected conditions are displayed emphatically on the genealogical tree.

12. A method as set forth in claim 9, wherein it is characteristic that if a user selects a patent displayed on a genealogical tree by using a mouse cursor, then the only patents described directly in the fields for the genealogical tree in prior patent databases are extracted and the only connection lines between the selected patents and the extracted patents on the genealogical tree are displayed emphatically.
